(19) United States
(12) Patent Application Publication
(10) Pub. No.: US 2007/0081453 A1
(43) Pub. Date: Apr. 12, 2007

(54) Method and apparatus for data transmission in a wireless communication system

(75) Inventors: Jung-Tsan Hsu, Taipei (TW); Yi-Ching Chen, Taipei (TW); Da-Jin Hsu, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/247,681

(22) Filed: Oct. 11, 2005

(51) Int. Cl. H04L 12/26; H04Q 7/00

(52) U.S. Cl. 370/229; 370/329

(57) ABSTRACT

A data transmission method and apparatus in a communication system to avoid data buffer overrun by using a smaller data buffer. The communication system includes an AP (access point) and a host device connected to a wireless device with a USB interface circuit. The wireless device includes a data buffer for receiving data from the AP. The data rate between the AP and the wireless device decreases or increases based on a utilization of the data buffer to avoid errors.

### BACKGROUND

The invention relates to a data transmission method for communication networks, for example, wireless LANS. More particularly, the invention relates to a method and an apparatus for avoiding data buffer overrun by a data rate adjusting mechanism in a wireless communication system.

A conventional wireless communication system 10 as shown in FIG. 1(a) includes an AP 130 and a wireless device 110 connected to a host computer via a USB interface 170. The wireless device includes an RF (radio frequency) section 112, a MAC (medium access control) controller 116, a baseband processor 114 and packet buffer 118. The host computer 120 includes a processor 122 and a packet buffer controller 140, which has USB interface mode controller 140.

FIG. 1(b) shows a flow chart of the conventional communication system as shown in the FIG. 1(a). In FIG. 1(b), the wireless device is plugged into the host computer via the USB interface (Step S100). Next, a supporting rate of the USB interface between the wireless device and the host computer is detected (Step S110). USB 2.0 has three operational modes, including H mode, F mode and L mode, which supports up to 480 Mbps, 12 Mbps and 1.5 Mbps, respectively. USB 1.1 has two operational modes, including F mode and L mode, which supports up to 12 Mbps and 1.5 Mbps, respectively. Finally, the wireless device is provided with a maximum data rate up to 54 Mpbs for communicating with the AP using 802.11g (Step S120).

If the data rate between a 802.11g station and an AP is 54 Mbps, the transmitted data (or transmitted packets) received by the wireless device will be queued at the USB device and the queued buffer will overrun if the bandwidth of USB full speed mode is only 12 Mbps. If the queued buffer is overrun, then the consequent transmitted data (or consequent transmitted packets) will not be received and will be re-tried from the AP, resulting in occupying extra wireless bandwidth of the wireless communication system.

In other words, the host computer will detect the supporting rate of the USB interface if the connector of the wireless device 110 with USB 1.1 interface is attached to the host computer 120. The supported data rate between the AP and the wireless device will be 1. 2 Mbps, 5.5 Mbps, 6 Mbps, 9 Mbps, 11 Mbps, 12 Mbps, 18 Mbps, 24 Mbps, 36 Mbps, 48 Mbps, and up to 54 Mbps if the wireless communication system adopts IEEE 802.11g standard. Although with a data rate up to 54 Mbps, read errors may occur due to the faster input (for example, 54 Mbps) between the AP and the wireless device and the slower output (for example, 12 Mbps) between the wireless device and the host computer. The transmission bottle neck will be at the USB interface as the full speed mode of the USB interface only supports a rate of up to 12 Mbps. That is to say the transmission data will queue at the USB interface. Therefore, the transmitted packet must be re-tried (or be re-sent) from the AP if the transmission queue buffer is overrun, the resulting transmission data (transmission packets) will occupy a part of the transmission bandwidth.

Three problems will occur in a conventional wireless communication system, which includes an AP, a host computer connected to a wireless device with an USB interface:

(1) The data buffer will overrun if the data rate between the host computer and the wireless device is faster than the buffer can be transmitted to the host computer.

(2) The transmission efficiency of the communication system will decrease if the data rate is much lower the USB support rate.

(3) The system reliability will be reduced if an unsuitable setting exists, for example the data rate between AP and the wireless device is faster than the supporting rate of the USB interface, which will cause the read error.

The disadvantages of the prior art follow:

(1) A larger data buffer is needed: The reduction in probability of data overrun can be achieved by increasing the buffer size, but the tradeoff is higher cost.

(2) Loss of data or reading error will occur in a communication system due to the receiving device being unable to accept data at the transmitted data rate, for example the data rate between the AP and the wireless device is much faster than the support rate of the USB interface.

### SUMMARY

It is therefore an objective of this invention to provide an improved data transmission method and apparatus in a communication network, which is designed for use with a portable computer connected to a wireless device with a USB interface or the like.

In accordance with the foregoing and other objectives of this invention, a new method and apparatus of data transmission is provided to avoid data buffer overrun via a dynamic adjusting data rate mechanism for the purpose of increasing the transmission efficiency of the communication system.

According to one embodiment of the present invention, the data transmission method is provided for a communication system, the communication system includes an AP (access point) and a host device connected to a wireless device with an USB interface circuit, the wireless device includes a data buffer for receiving data from the AP, comprising the steps of attaching the wireless device to the host device with the USB interface device; determining a first USB mode of the wireless device; detecting a first USB supporting rate according to the first USB mode; determining a first data rate between the AP and the wireless device according to the first data rate to avoid read errors; decreasing the first data rate to a second data rate between the AP and the wireless device if a utilization rate of the data buffer is larger than a first threshold value, wherein the second data rate is lower than the first data rate; increasing the first data rate to a third data rate if a utilization rate of the data buffer is less than a second threshold value (10%), wherein the third data rate is greater than the first data rate.

A wireless communication system including an AP and a wireless device is provided, the communication system includes an AP, a wireless device coupled to a host computer via USB interface, wherein the wireless device includes a first processor, an RF section, a data buffer (or Packet buffer) for receiving the transmission data from the AP, a MAC circuit coupled to the RF section, a buffer utilization detecting means for detecting a buffer status of the data buffer (or Packet buffer) and a USB interface circuit, wherein the host connected to the wireless device with the USB interface circuit, the host includes a second processor, a packet buffer controller includes a USB interface mode controller and a data rate controller for dynamically adjusting the data rate between the AP and the wireless device.

### DESCRIPTION OF THE DRAWINGS

The invention can be more fully understood by reading the subsequent detailed description and examples with references made to the accompanying drawings, wherein:

FIG. 1(a) shows a wireless communication system including an AP and a conventional wireless device;

FIG. 1(b) is a flow chart of a communication system of FIG. 1(a);

FIG. 2 shows a block diagram of a wireless communication system including an AP and a wireless device with a Wireless device and a USB interface;

FIG. 3 shows a block diagram of one another wireless communication system including an AP and a wireless device with a Wireless device and a USB interface;

FIG. 4(a) is the flow chart of the initial setting of FIG. 2 and FIG. 3;

FIG. 4(b) is a flow chart of step A as shown in FIG. 4(a) of the present invention;

FIG. 5 is a flow chart of initialization for the data rates and the USB mode for the present invention in FIG. 4; and

FIG. 6 shows a table listing data rates of the AP, host and the USB interface in the present invention.

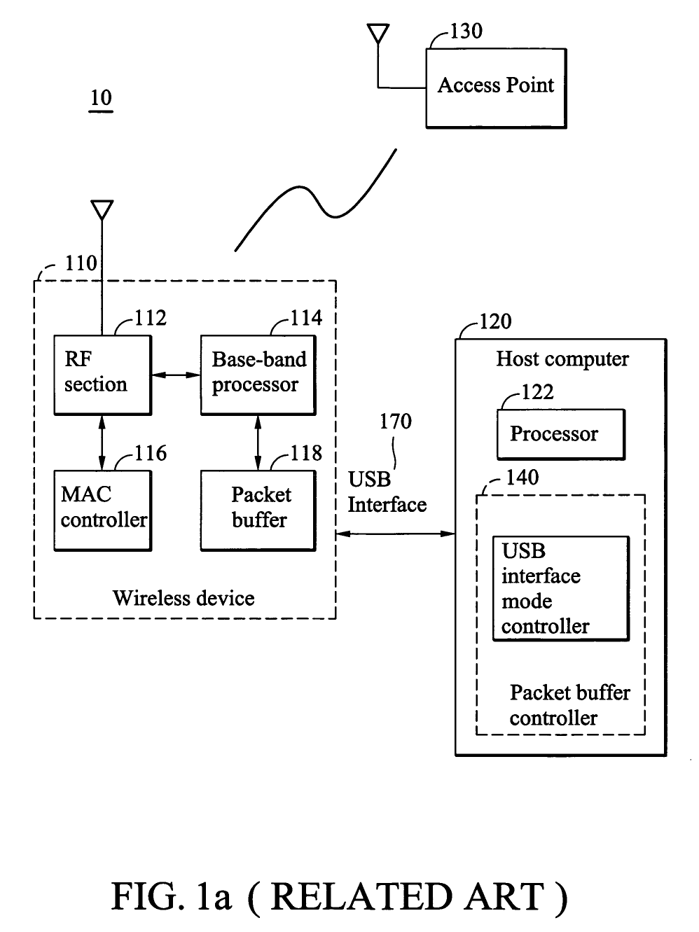

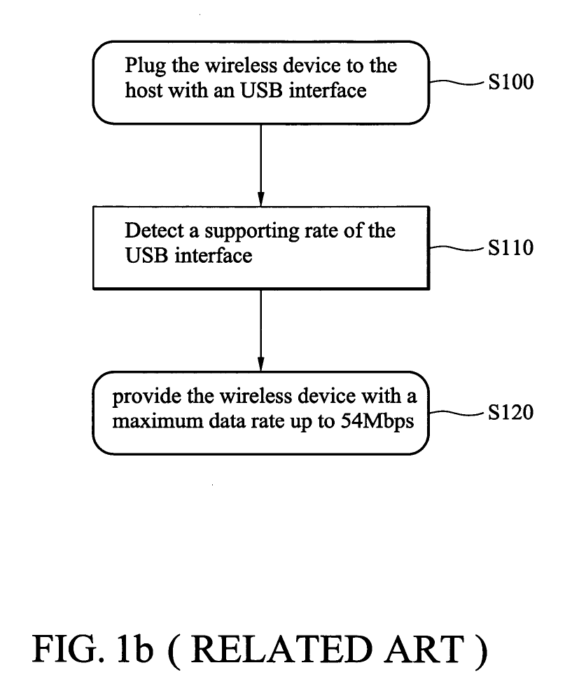

### DESCRIPTION

### First Preferred Embodiment

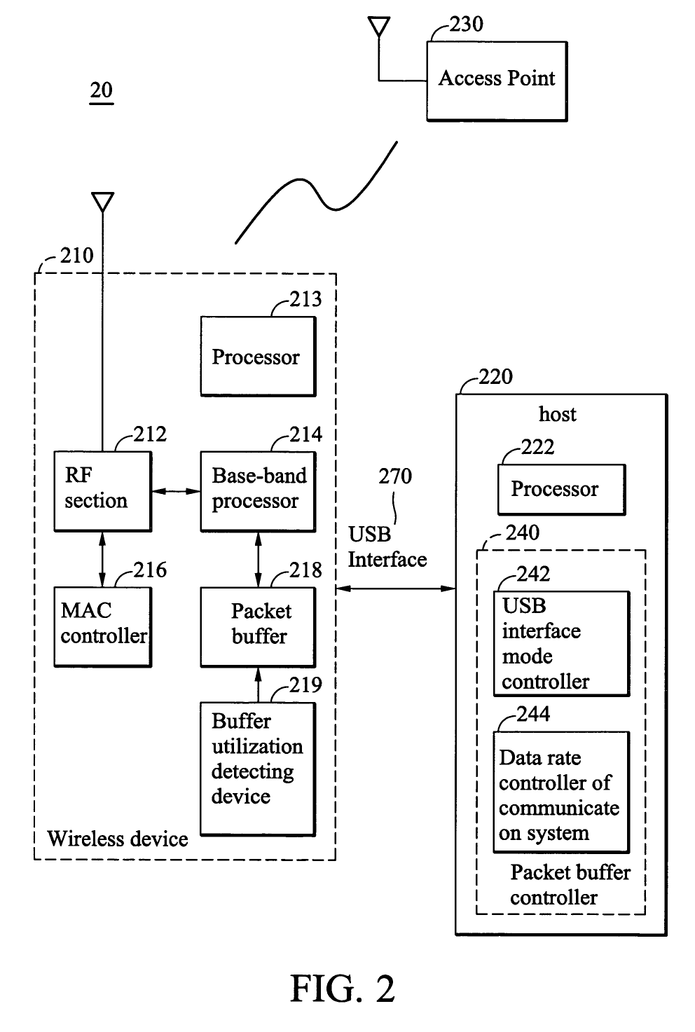

The invention provides a data transmission method and apparatus of a wireless communication system including an AP and a wireless device connected to a host using an USB interface. As shown in FIG. 2, the communication system 20 includes an AP 230 and a wireless device 210 coupled to a host computer 220 by an USB interface 270.

The wireless device 210 includes a first processor 213, an RF section 212, a data buffer (or packet buffer) 218 for receiving the transmission data from the AP 230, a MAC controller 216 coupled to the RF section 212, a buffer utilization detecting device 219 for detecting a buffer status of the data buffer 218 (or packet buffer) and an interface circuit for the USB interface 270.

The host 220 is connected to the wireless device 210 using the USB interface 270. The host 220 includes a second processor 222 and a packet buffer controller 240. The packet buffer controller 240 includes an USB interface mode controller 242 and a data rate controller 224 for dynamically adjusting the data rate between the AP and the wireless device.

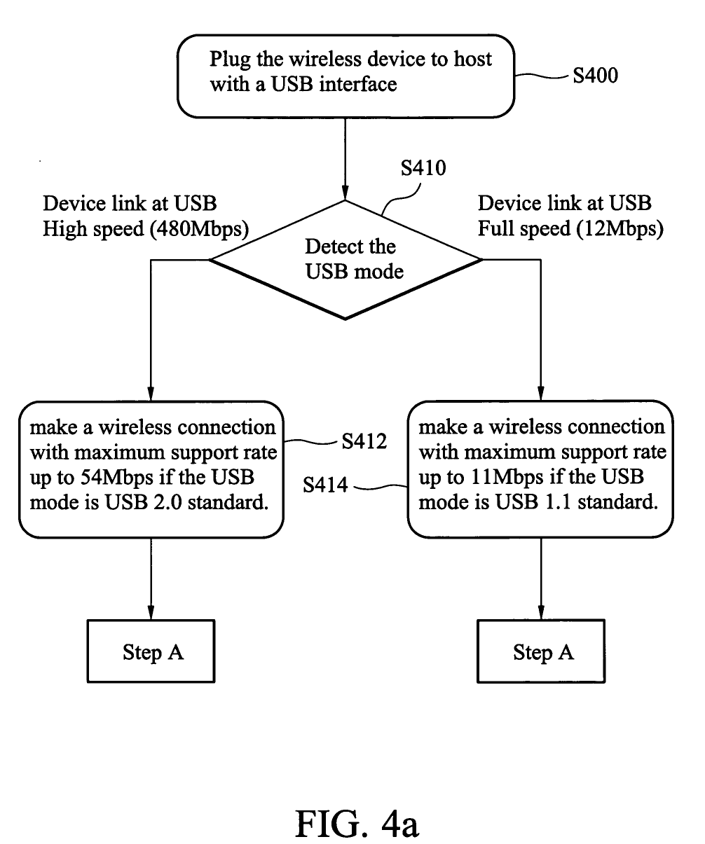

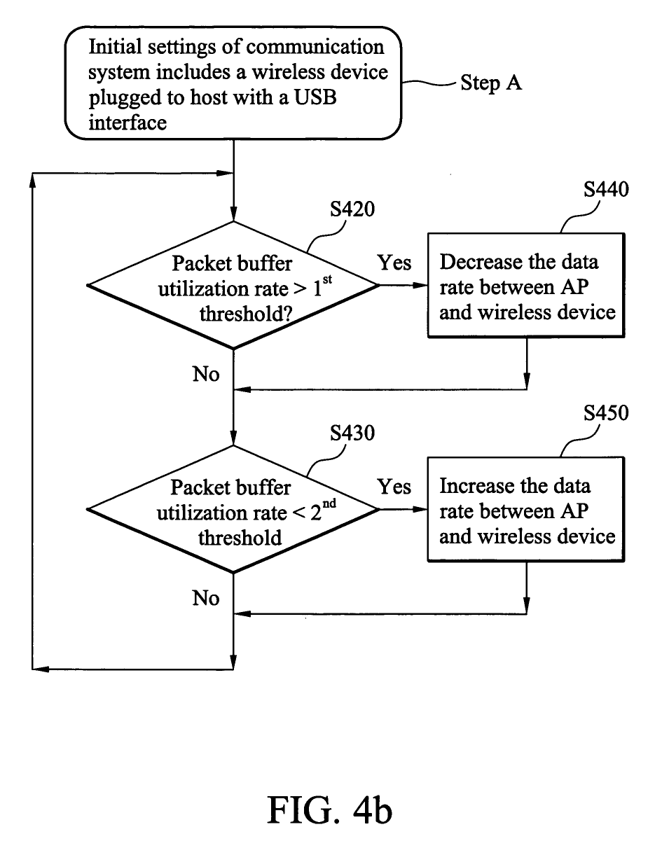

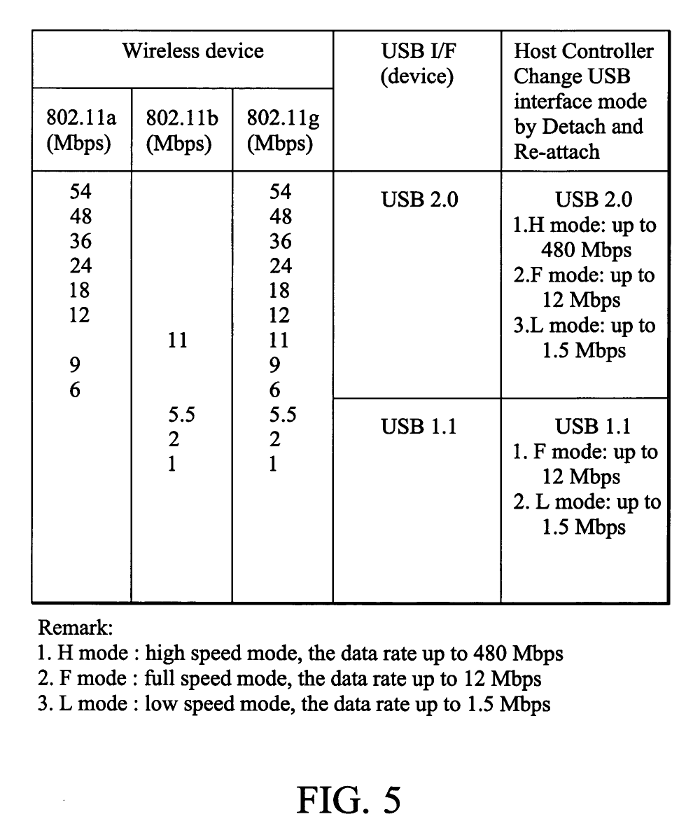

FIG. 4(a) shows a flow chart of determining an initial setting of the USB support rate in the wireless communication system in FIG. 2. The operation of the flow chart of FIG. 4(a) includes the following main steps.

(1) At step S400, the wireless device is connected to the host computer using the USB interface.

(2) At step S410, the USB mode of the USB interface is detected.

(3) At step S412, a wireless connection with maximum support rate up to 54 Mbps is established if the USB mode is USB 2.0 standard.

(4) At step S414, a wireless connection with maximum support rate up to 12 Mbps is established if the USB mode is USB 1.1 standard.

### Second Preferred Embodiment

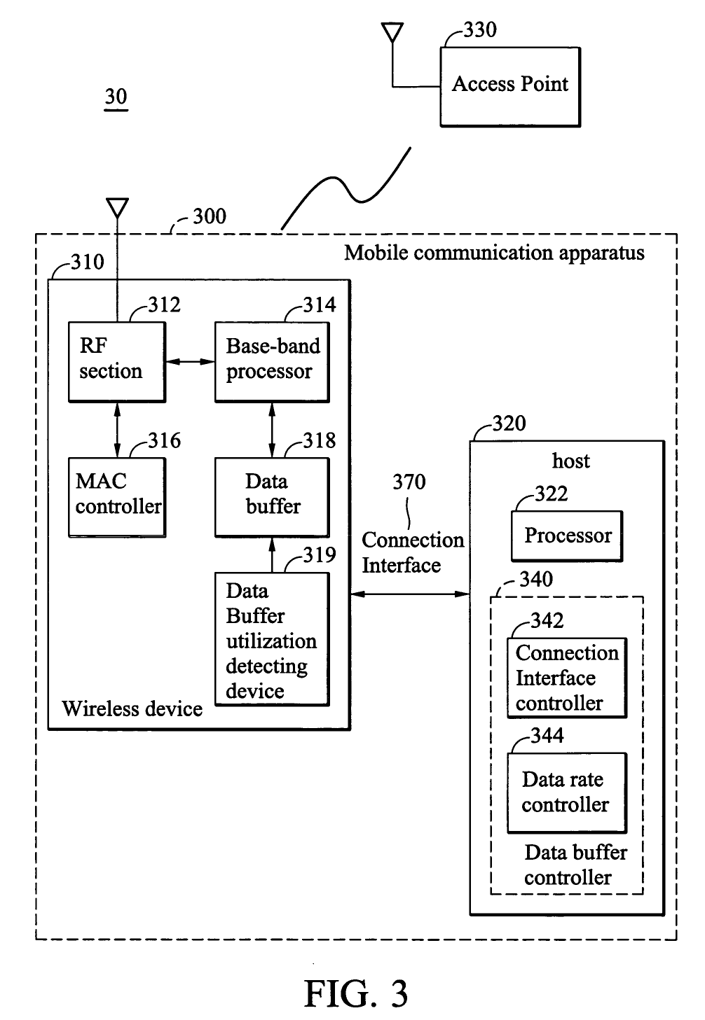

FIG. 3 illustrates a wireless communication system including an AP and a wireless device connected to a host device using an USB interface in accordance with a second preferred embodiment of the present invention.

A wireless communication system 30 includes an AP 330 and a mobile communication apparatus 300.

The mobile communication apparatus 300 includes a wireless device 310 and a host 320 connected to the wireless device 310 with a connection interface 370.

The wireless device 310 includes a RF section 312, a baseband processor 314, a data buffer 318 for receiving the transmission data from the AP 330, a MAC controller 316 coupled to the RF section 312, a buffer utilization detecting device 319 for detecting a buffer status of the data buffer and an interface circuit for the connection interface 370.

The host 320 is connected to the wireless device 310 using the connection interface 370. The host 320 includes a processor 322 and a packet buffer controller 340. The packet buffer controller 340 includes a connection interface mode controller 342 and a data rate controller 324 for dynamically adjusting the data rate between the AP 330 and the wireless device 310.

The present invention can be applied to the following communication systems:

1. An AP and a portable computer connected to a 802.11a/g wireless LAN card with an USB interface adaptor.

2. An AP and a Notebook PC connected to a 80211a/b/g wireless LAN card with an connection interface adapter.

The hardware of the wireless device of the preferred embodiment can have an internal processor 213 as shown in FIG. 2 or by means of an external processor 320 as shown in FIG. 3 to control the related function blocks in the communication system to dynamically adjust the data rate between the AP and the wireless device. The packet buffer can be an embedded memory, for example, registers, flip-flop, etc. We can also use external memory, for example, DRAM, SRAM, flash memory, or the like to act as the packet buffer. FIG. 4(b) shows a flow chart of step A as shown in FIG. 3. The descriptions of the flow chart of FIG. 4(b) are shown as the following:
(1) At step A, initial settings of a communication system includes a wireless device plugged to host with a USB interface;
(2) At step S420, it is determined whether the packet buffer overrun or not, i.e. whether the packet buffer utilization rate is larger than a first threshold or not. If the answer is yes, then go to the step S440, else go to the step S430.
(3) At step S430, it is determined whether the packet buffer utilization rate is less than a second threshold or not.
(4) At step S440, the data rate between AP and wireless device is decreased.
(5) At step S450, the data rate between AP and wireless device is increased.
   Data Rate Adjusting Mechanism

The following examples can be applied to the data rate adjusting mechanism of the preferred embodiments of the present invention.

Definitions

1. USB bus Bandwidth for Rx=Bulk In Data (bits)/SOF time (125 μs for High speed, 1 ms for Full speed)

2. Wireless Support Rates(data rate between the AP and the wireless device):
802.11b—1, 2, 5.5, 11 Mbps
802.11g—1, 2, 5.5, 11, 6, 9, 12, 18, 24, 36, 48, 54 Mbps
802.11a—6, 9, 12, 18, 24, 36, 48, 54 Mbps

3. Device Rx buffer utilization ratio=Rx Data in Packet Buffer/Total Rx Buffer

4. Rx buffer overrun: Device Rx buffer utilization ratio==100% and receive more Packets.

Dynamic Rx Data Rate Control flow

1. Initial Rx Data Rate is maximum wireless support rate. (54 Mbps for 802.11a/g, 11 Mbps for 802.11b).

2. Rx Data Rate Control while overrun: Set maximum Rx Data Rate<=USB bus bandwidth for Rx.

3. Rx Data Rate Control while Rx buffer utilization ratio<50%: increase maximum Rx Data Rate up to the maximum support rate.

The data rate adjusting mechanism is to adjust the current rate to a Dynamic Rx Data Rate according to the range of USB bus bandwidth.

### Example A for 802.11g

| | Rx buffer | Dynamic | |
|---|---|---|---|
| | utilization ratio | Rx Data Rate | |
| Overrun | <50% | adjust | |
| | Current Rate | 54 | Mbps |
| | is 48 Mbps | | |
| 36 < USB bus | Current Rate | 48 | Mbps |
| bandwidth <= 48 (Mbps) | is 36 Mbps | | |
| 24 < USB bus | Current Rate | 36 | Mbps |
| bandwidth <= 36 (Mbps) | is 24 Mbps | | |
| 18 < USB bus | Current Rate | 24 | Mbps |
| bandwidth <= 24 (Mbps) | is 18 Mbps | | |
| 11 < USB bus | Current Rate | 18 | Mbps |
| bandwidth <= 18 (Mbps) | is 11 Mbps | | |
| 5.5 < USB bus | Current Rate | 11 | Mbps |
| bandwidth <= 11 (Mbps) | is 5.5 Mbps | | |
| 2 < USB bus | Current Rate | 5.5 | Mbps |
| bandwidth <= 5.5 (Mbps) | is 2 Mbps | | |
| 1 < USB bus | Current Rate | 2 | Mbps |
| bandwidth <= 2 (Mbps) | is 1 Mbps | | |
| USB bus bandwidth <= 1 (Mbps) | | 1 | Mbps |

### Example B for 802.11a

| | Rx buffer | Dynamic |
|---|---|---|
| | utilization ratio | Rx Data Rate |
| Overrun | <50% | adjust |
| | Current Rate | 54 Mbps |
| | is 48 Mbps | |
| 36 < USB bus | Current Rate | 48 Mbps |
| bandwidth <= 48 (Mbps) | is 36 Mbps | |
| 24 < USB bus | Current Rate | 36 Mbps |
| bandwidth <= 36 (Mbps) | is 24 Mbps | |
| 18 < USB bus | Current Rate | 24 Mbps |
| bandwidth <= 24 (Mbps) | is 18 Mbps | |
| 12 < USB bus | Current Rate | 18 Mbps |
| bandwidth <= 18 (Mbps) | is 12 Mbps | |
| 9 < USB bus | Current Rate | 12 Mbps |
| bandwidth <= 12 (Mbps) | is 9 Mbps | |
| 6 < USB bus | Current Rate | 9 Mbps |
| bandwidth <= 9 (Mbps) | is 6 Mbps | |
| USB bus bandwidth <= 6 (Mbps) | | 6 Mbps |

### Example C for 802.11b

| | Rx buffer | Dynamic | |
|---|---|---|---|
| | utilization ratio | Rx Data Rate | |
| Overrun | <50% | adjust | |
| | Current Rate | 11 | Mbps |
| | is 5.5 Mbps | | |
| 2 < USB bus | Current Rate | 5.5 | Mbps |
| bandwidth <= 5.5 (Mbps) | is 2 Mbps | | |
| 1 < USB bus | Current Rate | 2 | Mbps |
| bandwidth <= 2 (Mbps) | is 1 Mbps | | |
| USB bus bandwidth <= 1 (Mbps) | | 1 | Mbps |

In conclusion, the data transmission method and system of the invention has the following advantages. First, it can reduce the power consumption by decreasing the data rate between the AP and the wireless device. Second, it is possible by means of a simple data transmission method to avoid data buffer overrun by using a smaller data buffer.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data transmission method for a communication system, the communication system including an AP (access point) and a host device, and a wireless device with USB (universal serial bus) interface circuit, the wireless device including a data buffer for receiving data from the AP, comprising the steps of:
(a) attaching the wireless device to the host device using the USB interface device;
(b) determining a first USB mode of the wireless device;
(c) detecting a first USB support rate according to the first USB mode; and
(d) determining a first data rate between the AP and the wireless device according to the first USB support rate to avoid reading errors; and
(e) adjusting the first data rate between the AP and the wireless device according to a utilization rate of the data buffer.

2. The method as claim in the claim 1, wherein in the step of adjusting the first data rate further comprises the steps of:
(e1) decreasing the first data rate to a second data rate between the AP and the wireless device if the utilization rate of the data buffer is larger than a first threshold value, to prevent the data buffer from being overrun, wherein the second data rate is lower than the first data rate;
(e2) increasing the first data rate to a third data rate if the utilization rate of the data buffer is less than a second threshold value, wherein the third data rate is higher than the first data rate.

3. The method as claim in the claim 1, wherein in the step of detecting a first USB support rate according to the first USB mode, the first USB support rate is 480 Mbps (High speed) if the first USB mode is the USB 2.0 standard.

4. The method as claim in the claim 1, wherein in the step of detecting a first USB supporting rate according to the first USB mode, the first USB support rate is 12 Mbps (Full speed) if the first USB mode is the USB 1.1 standard.

5. The method as claim in the claim 1, wherein in the step of determining the first data rate between the AP and the wireless device according to the first USB support rate, the first data rate is a data rate supported between the AP and the wireless device which is the nearest to the first USB support rate.

6. The method as claim in the claim 5, wherein the first data rate is 54 Mbps for the IEEE 802.11a/g standards.

7. The method as claim in the claim 5, wherein the first data rate is 11 Mbps for the IEEE 802.11b standards.

8. The method as claim in the claim 2, wherein in the step of decreasing the first data rate to a second data rate between the AP and the wireless device if the utilization rate of the data buffer is larger than the first threshold value, the first threshold value is 50%.

9. The method as claim in the claim 2, wherein in the step of decreasing the first data rate to the second data rate between the AP and the wireless device if the utilization rate of the data buffer is larger than the first threshold value, wherein the second data rate is a lowest data rate between the AP and the wireless device.

10. The method as claim in the claim 9, wherein the second data rate is 6 Mbps for the IEEE 802.11a standard.

11. The method as claim in the claim 9, wherein the second data rate is 1 Mbps for the IEEE 802.11a/g standard.

12. The method as claim in the claim 2, wherein in the step of increasing the first data rate to the third data rate if the utilization rate of the data buffer is less than the second threshold value, the second threshold value is 10%.

13. The method as claim in the claim 1, wherein in the step of determining the first data rate between the AP and the wireless device according to the first data rate, the third data rate is selected from a group of 54, 48, 36, 24, 18, 12, 9 and 6 Mbps for the 802.11a standard.

14. The method as claim in the claim 1, wherein the step of determining the first data rate between the AP and the wireless device according to the first data rate, the third data rate is selected from a group of 11, 5.5, 2 and 1 Mbps for the 802.11b standard.

15. The method as claim in the claim 1, wherein in the step of determining the first data rate between the AP and the wireless device according to the first data rate, the third data rate is selected from a group of 54, 48, 36, 24, 18, 12, 11, 9, 6, 5.5, 2 and 1 Mbps for the 802.11g standard.

16. A wireless communication system comprising an AP (access point) and a wireless device connected to a host device, wherein the wireless device comprising:
an RF (radio frequency) section;
a data buffer coupled to the RF section for receiving data from the AP;
a MAC (medium access control) controller coupled to the RF section;
a buffer utilization detecting means for detecting a buffer status of the data buffer; and
an USB interface circuit for communicating with the host device;
wherein the host device connected to the wireless device using the USB interface circuit, comprising:
a data buffer controller comprising:
a USB interface mode controller for detecting first USB mode of the wireless device; and
a data rate controller for dynamically adjusting the data rate between the AP and the wireless device according to the first USB mode.
